(19) United States
(12) Patent Application Publication
(10) Pub. No.: US 2017/0091395 A1
(43) Pub. Date: Mar. 30, 2017

(54) Centralized Medical Information System

(71) Applicants: Wing L. May, Scotch Fields, NJ (US); David Andersen, Salt Lake City, UT (US); Brenden Anderle, Salt Lake City, UT (US)

(72) Inventors: Wing L. May, Scotch Fields, NJ (US); David Andersen, Salt Lake City, UT (US); Brenden Anderle, Salt Lake City, UT (US)

(21) Appl. No.: 15/279,945

(22) Filed: Sep. 29, 2016

Related U.S. Application Data
(60) Provisional application No. 62/234,398, filed on Sep. 29, 2015.

(51) Int. Cl. G06F 19/00; G06F 21/62

(52) U.S. Cl. CPC G06F 19/322; G06F 19/321; G06F 19/328; G06F 21/6245; G06F 19/3456

(57) ABSTRACT

A centralized computer system for managing, storing and providing access to patient medical information, allowing both the user and medical personal immediate access to critical patent information via the Internet, telephone network or mobile cellular devices, and helping to bridge any communications gaps that may exist between a patient user and a medical provider.

The present application claims priority to U.S. Provisional Application 62/234,398, filed Sep. 29, 2015; the disclosure of the provisional application incorporated by reference.

### BACKGROUND OF THE INVENTION

The present invention relates generally to medical information systems, including but not limited to, centralized medical information systems for managing, storing, and providing patient medical information to health care providers at remote locations.

Every year, many people become either seriously ill or die because their healthcare provider is not able to access the important information needed from the patient, especially in an emergency situation, such as a car accident or a serious illness. Doctors have to obtain the much-needed information from the patient, such as his blood type, allergies to medication, or important health information. A computer-based patient information network could be a lifesaver for a seriously ill or injured patient who needs emergency care.

Mr. Wing May is a foreign-born, naturalized citizen from Asia. All of his senior relatives are illiterate in English. When they received care from a healthcare provider, they could not fill out a patient history form. Although Mr. May is fluent in English, the medical care giving process is not. For example, some prescription drugs have names that are very long and complicated. The name can be very difficult to remember, let alone to spell and write correctly.

One day, one of Mr. May's relatives called him late at night. No one in the whole family of that patient could speak English. When the ambulance came, Mr. May was the only one they knew who is fully bilingual and also picked up the phone late at night.

One time, Mr. May took one of his sons to an emergency room late at night. The staff at the hospital gave him a large pile of paperwork to fill out. It took him an hour to complete despite the fact his minor son needed emergency assistance.

In a separate incident, his daughter had to undergo an emergency surgery. A team of surgeons had asked him all sorts of questions. He did not have all of her records with him, including her CAT scans. All he could provide them with was the information he had available.

Every time a patient visits a doctor, they are always faced with a multitude of paper forms and questions. Wouldn't it be easier if there could be a computer-based network with which one could access the information needed by a healthcare provider?

When dealing with an unconscious patient after an accident, a patient who is seriously ill, a patient suffering from Alzheimer's disease, or a patient suffering from a mental disorder, the patient may be unable to provide the information needed. A lot of foreign-born immigrants cannot read or write in the English language. Even some American-born people are on medications and have diagnoses with names that are difficult to spell correctly. We should have a computer-based network that can provide the healthcare providers with the information they need, especially in an emergency.

### SUMMARY OF THE INVENTION

It is an objective of the present disclosure to provide a centralized computer system for managing and storing patients' medical information that is accessible from remote locations that allows the medical professionals and the patients themselves to access the patients' medical information through remote electronic devices, such as smart phones and computers.

It is an objective of the present disclosure to provide faster access to patient information in order to increase patient survival rates, especially if the patient is unconscious or cannot speak English.

It is an objective of the present disclosure to provide each enrolled patient with a life-saving tag. The tag is a small tag that can be hung from the patient's neck or wrist, or attached to their phone or mobile device. On the front side of the lifesaving tag, there is a toll-free number, a website address, and an account number. A healthcare professional, without any directions, would understand the meaning of the tag. It is a further objective of the present disclosure to provide the lifesaving tag with a rear side. The first line on the rear side indicates if the patient is suffering from any serious illness. If there is an exclamation point, the condition is serious. The second line indicates if the patient has any transmittable diseases. The third line indicates if the patient is allergic to anything. The fourth line has his blood type, and the issue date of that tag. Everyone can easily understand this product without much training Both sides of the tag are marked with the colorful logo and with luciferin to make it easier to see in the dark.

It is a further objective of the present disclosure to provide a centralized computer system for managing and storing patients' medical information that is connected to a telephone network for receiving telephone calls from patients or health care providers. The centralized computer system can identify an enrolled patient through caller ID. There is an automated answering system. If the caller presses “1” if he is the patient himself or “2” if he is calling on behalf of someone else. If the caller is calling on behalf of someone else, the answering system will ask for the patient's account number. For fast and easy access, the security code should be all numbers and no letters because not all phones come with keyboards.

It is further an objective of the present disclosure to provide for family members covered by the same insurance policy. Every individual in the family should have his own account number, but the same security code. As a result, the parents could have access to their minor children's information without having to remember each individual's security code.

It is further an objective of the present disclosure to allow EMTs, doctors, and other healthcare professionals administrative rights to access a patient's health care records. For example, when they call the centralized computer system, they only have to enter the patient's account number so they can read the patient's medical information without the security code. In an emergency situation, time is life.

It is further an objective of the present disclosure to provide a technique for downloading a patient's CAT scans, x-rays, and other results into the centralized medical record system from a cell phone or other electronic device. If the internet service for the PC is down, a person can connect to the PC via BlueTooth with a cellphone. It is further an objective of the present invention to allow a healthcare professional administrative rights to review, add, and change the patient's stored medical information. But for security reasons, whoever adds or changes the information needs to enter a security code. The security code is only given to primary medical provider. If a patient wants to review his information, he does not need a security code as the updated medical information is available on the patient's smart phone or mobile device.

It is further an objective of the present invention to allow a patient to fill out the patient information form online. There will be a patient information background form on the Internet site. When a patient needs to visit a new medical provider, the provider would have him fill out such a form—a new patient intake form. With the patient's information already captured in the online system, the provider need only ask questions regarding specialized treatment. The advantage of such an invention is if the patient is unable to read or write English. A bilingual person could help him fill out such a form online, even if he is not present.

One of the major advantages of accessing the patient's information through a cellphone pursuant to the present disclosure is it can be done hands free. The medical professionals with a cellphone can just call in the network. The networking system with the caller ID will immediately identify the caller having the administrative rights to access the patient's information. He can just read the patient's account number, located on the life-saving tag and the information can be accessed immediately. As part of the system implementation, there is a live operator responding to calls. If the phone call is from a patient who needs immediate help, such as needing an ambulance, he could just say “I need help now”, the networking system will immediately transfer the call from the automated program to an operator who will answer the phone immediately.

It is further an objective of the present disclosure to avoid a large complex account number to access a centralized computer system because it is too hard to remember and complicated. The present disclosure provides a centralized computer system that utilizes voice recognition of a user's name and four digit pin number. For example: The computer will recognize all the David C. Andersen's with a pin number of 5555 via a cell phone or a regular phone. This reduces the number of matches down to a handful instead of hundreds of thousands then the computer can search the recorded voiceprint using voiceprint technology and can immediately and accurately identify the caller. Everyone can remember a four-digit personal identification number (PIN) and it would make the computer processing effort much simpler.

It is a further objective of the present invention, the system uses caller ID to identify the caller's identity, including his national origin and primary language. Each patient account has pertinent information about the patient including a contact phone number that is attached to the caller ID function and their primary language. As an example, the inventor “Wing May” is of Chinese origin. When he calls the network operator, the caller ID recognizes him and his identity, and connects him to a Chinese-speaking operator. This is an important implementation issue because there are over forty million foreign born immigrants, many of whom don't speak English. In an emergency situation, some non-English speaking people can't call 911 because of language barriers. All of the Medifax system operators are bilingual. If the caller does not communicate in English, the bilingual operator can make a phone call for him.

In yet another objective of the present invention, mini-cell phone is provided for its senior customers. Currently, some companies issues panic buttons, which hang on someone's neck like a necklace. Such a system cannot call anyone but the operator. The “mini phone” works like a small cell phone. The difference is there is a panic button on the phone. If the patient is suddenly feeling sick, he or she can just press the button and the phone will immediately connect the call to an operator who speaks his language.

In one embodiment, the mini phone, or the patient's mobile phone attached to the account, is able to remind them to take their medicine, in their own language, on the schedule as prescribed by the doctor. The patient or their caregiver should contact the operator. The operator has his voice recorded in the automatic calling machine. This uses the same technique as a telemarketer making phone calls to the customers. When it is time to take a prescription drug, the automatic calling machine will call the patient to remind them to take which kind of medication (even reminding them what it looks like). If there is no answer, the machine will call again.

### BRIEF DESCRIPTION OF THE DRAWINGS

The features and advantages of the disclosure will become apparent from a consideration of the subsequent detailed description presented in connection with the accompanying drawings in which:

FIG. 1 is a centralized medical information system according to an embodiment of the present disclosure;

FIGS. 2A and 2B depict a front and back view of a patient tag according to an embodiment of the present disclosure;

FIGS. 3A, 3B, 3C, 3D and 3E depict the interactions of the components of the centralized medical information system according to an embodiment of the present disclosure;

FIG. 4 depicts the patient information background form. Such form could be filled out online and printed out easily, and;

FIG. 5 is one embodiment of the miniphone of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

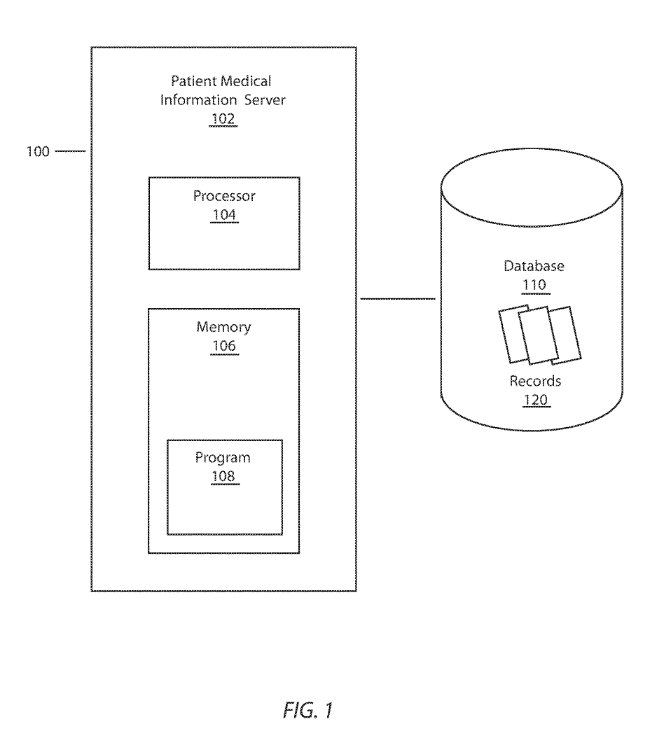

With reference now to the figures, and in particular with reference to FIG. 1, there is illustrated an exemplary environment in accordance with the present invention. Embodiments of the present invention advantageously provide a system and methods for facilitating the exchange of medical information between health care providers and patients. Embodiments of the present invention also include a computer readable medium containing a set of instructions or program causing the computer system to facilitate according to the present invention, and a database of personal networks and business networks formed by users of the computer system.

A system 100 includes a computer system positioned at a site to define a patient medical information server 102. The server 102 may include a processor 104 and a memory 106 as known to those having ordinary skill. A patient information management program 108, is stored in the memory 106. The program 108 may define a set of computer-readable instructions that, when executed by the processor 104, cause the processor 104 to perform the functions as described herein.

It will be understood that the preferred specific server 102 identified above is given by way of example and that other types of servers or computers may be used. In an embodiment, the server 102 represents a server or server cluster or server farm in the architecture and is not limited to any individual physical server. The server site may be deployed as a server farm or server cluster managed by a serving hosting provider. The number of servers and their architecture and configuration may be increased based on usage, demand and capacity requirements for the system 100.

The system 100 further includes in database 110. In an embodiment, the database 110 comprises a set or grouping of databases stored in the memory of the server 102 or in other suitable electronic data storage media, such as a hard drive, accessible to the server 102. The database 110 may also be provided in the form of a database server or server cluster. The particular database configuration is replicated based on capacity requirements for the system 100. The database 110 or databases further include at least a plurality of records 120 having medical data relating to a plurality of users.

The patient information management program 108 according to the present invention may be stored in a machine-readable storage medium, such as, but not limited to, any type of computer data storage disk including floppy disks, CD-ROMs, optical disks, magneto-optical disks, read-only memories (or ROMs), EPROMs, EEPROMs, random access memories (RAMs), magnetic or optical cards, or other types of media suitable for storage of a set of instructions that, when executed by the processor 104, causes the server 102 to perform the operations of the present invention.

The program set of instructions described in the present invention are not inherently related to or required by a particular computer or other server hardware. Various conventional computers or servers may be used according to the present invention. In addition, the present invention is not described with reference to any particular programming language. It will be understood that a variety of programming languages may be used to implement the system and method of the present invention as described herein.

In an embodiment, the server 102 provides an online user registration process. The registration process allows users to establish accounts with the server 102. As part of the registration process, the server 102 may prompt the user to provide health care information, including name, address, insurance information, health care provider information, and health information. The user may complete the registration process using a remote electronic device (not shown) that is connected to the server 102 over a network, such as the Internet. It will be appreciated that the user may also provide information for groups of individuals, including families. This feature may be particularly useful when the user has minor children who are unable to complete the registration process themselves.

As part of the enrollment process provided by the server 102, the server 102 may prompt the user to provide a voice sample. It will be appreciated that the voice sample will be utilized by the server 102 to identify the user in the future using voice recognition technology. For example, the server 102 may compare the voice sample obtained from the user in the future to the voice print obtained during the registration process to positively confirm the identification of the user. In this regard, the server 102 may be connected to a telephone network.

As part of the registration process, the user may authorize the server 102 to obtain electronic medical records from third parties, such as past and current health care providers. In regard to the type and content of the health care records, it will be appreciated that the server 102 may obtain any and all types of health care records. Healthcare providers, such as physicians, create large volumes of patient information during the course of their business at healthcare facilities, such as hospitals, clinics, laboratories and medical offices. For example, when a patient visits a physician for the first time, the physician generally creates a patient file including the patient's medical history, current treatments, medications, insurance and other pertinent information. This file generally includes the results of patient visits, including laboratory test results, the physician's diagnosis, medications prescribed and treatments administered. During the course of the patient relationship, the physician supplements the file to update the patient's medical history. When the physician refers a patient for treatment, tests or consultation, the referred physician, hospital, clinic or laboratory typically creates and updates similar files for the patient. These files may also include the patient's billing, payment and scheduling records.

Healthcare providers can use electronic data processing to automate the creation, use and maintenance of their patient records. As part of the registration process, the user may further authorize the server 102 to obtain electronic insurance information from third parties, such as a health insurance company. All of the user's information is stored in the database 110 in a manner known to those of ordinary skill. The patients medical records in electronic form are generally known as Electronic Health Record (EHR) or Electronic Medical Record (EMR) and may be referred to using these abbreviations.

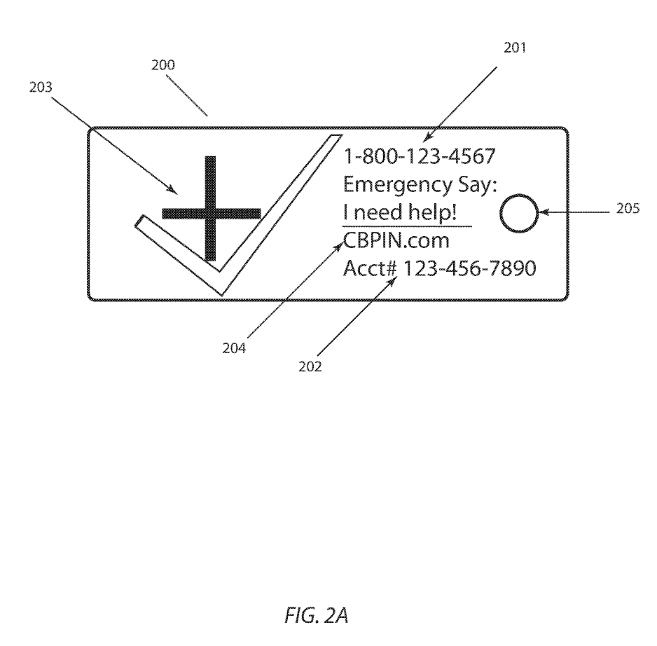

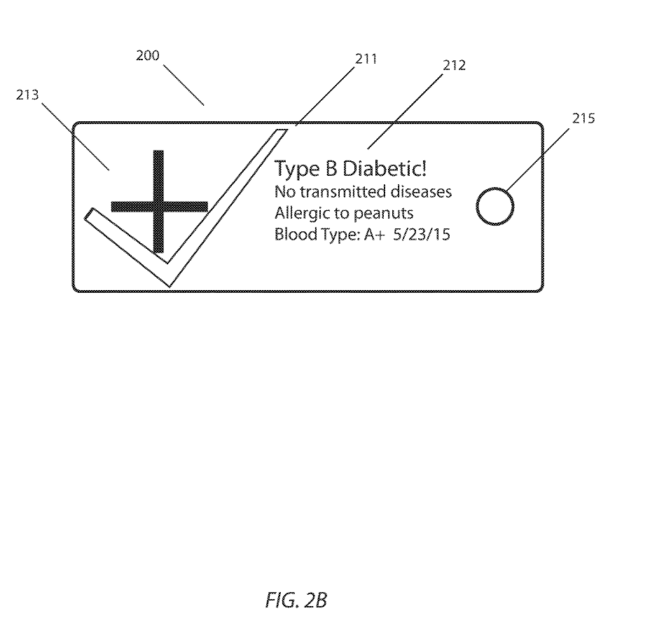

Once a user has enrolled with the server 102, the server 102 may assign the user an account number and a pin. In an embodiment, the account number is a numerical account number or an alphanumeric account number. The server 102 may also assign the user a key or a pin number that is utilized for security purposes. The server 102 may also assign the user a barcode or other identifier. Referring now to FIGS. 2A and 2B, the operator of the server 102 may issue a physical account identifier 200 to the user. The identifier 200 may include a front side 201, as shown in FIG. 2A, having sufficient information 202 for accessing the user's information stored in the database 110 in a manner that will be further described below. In an embodiment, the identifier 200 may take one of many forms, including a tag, having a hole 205/215, a bracelet, a necklace or a card. In an embodiment, each patient is issued a life-saving tag. The tag is a small tag that can be hung from the patient's neck or wrist. On the front side of the lifesaving tag, there is, company identifier 204, a toll-free number, a website address, and account number. A healthcare professional without any directions would understand the meaning of the tag.

On the rear side of the tag 211 as shown in FIG. 2B, displays the immediate patient information 212, including the first line which indicates if the patient is suffering from any serious illness. If there is an exclamation point, the condition should be noted by medical personnel or an emergency responder. The second line indicates if the patient has any transmittable diseases. The third line indicates if the patient is allergic to anything. The fourth line has his blood type, and the issue date of that tag. This idea is simple. Everyone can easily understand this product without much training Both sides of the tag are marked with the colorful logo 203/213 and with luciferin to make it easier to see in the dark.

In an embodiment, a user's medical information is accessed on the server 102 utilizing a voice print of the user's name and four-digit pin number. For example, the server 102 will recognize all of the users having a name associated with a pin number of 5555 transmitted via a cell phone or a regular phone to the server 102. This reduces the number of matches down to a handful, instead of hundreds or thousands; the computer can search the recorded voiceprint using voiceprint technology and immediately and accurately identify the user. This will allow a user to remember a four digit personal identification number (PIN) and it would make the computer processing effort much simpler. In an embodiment, the pin number is the last four digits of the patient's social security number.

The following is a list of features provided by the system 100:
Dog tag style ID cards (as per illustration)
Recognition of user using caller ID's
A smart phone application
Pin number
Personal information, such as name, birth date, gender, address, phone number, E-mail
Social Security number encrypted for security
Emergency contact person phone number
Power of attorney or legal guardian
Known allergies for medicine, food, or latex
Transmissible diseases
Medical insurance company, group and account number, including secondary insurance
Employer information
Primary care doctor and other medical professionals familiar with the patient
Pharmacy of the patient
CAT scans, X-rays, MRI's scan, etc.
Immunization record
Current prescription drugs
Medical history of the patient
Blood type, DNA, R.H. factor, etc.
Dental records
Organ donor status
POLST form
DNR & History

It is an object of the present disclosure to provide a centralized patient information system that provides the following features:
IVR (Interactive Voice Response) telephony interface
Electronic Health Record (EHR) data repository
Document Management System (DMS)
Web Application for Providers, Patients and Administration
Persistent Storage—relational or NoSQL
Call center support
Mobile device apps iOS, Android, Windows Phone, etc
ETL for non-digital medical & health records
   Each of foregoing features is described below.

### IVR (Interactive Voice Response) Telephony Interface

Telephony interface that allows voice calls to be processed by automated systems. In the case of a request for information, the IVR would send a link to the phone (presuming that phone has data capability) and that would allow access via a mobile device app to display the patient information. If the requirement is that verbal information be given, then a text-to-speech application will be required to provide the critical information to the caller.

### Electronic Health Record (EHR) Data Repository

There are several EHR cloud-based systems (HIPAA certified) to store the patient information including diagnostic image links (the actual documents are stored in the DMS).

### Document Management System (DMS)

Using a DMS such as Alfresco® or other, the document images are stored and administered here, again accessed through the web application using the EHR interface.

### Web Application for Providers, Patients and Administration

Primary application to integrate all of the services together as a coherent product. All patient, provider and administration functions are provided by a web interface and service API's to the users. The mobile applications invoke the API's for data retrieval and storage.

### Persistent Storage—Relational or NoSQL

Relational database system such as MySQL® or PostgreSQL®, non-relational document-based persistent stores such as Elasticsearch®. This is the primary store for the account, provider and other information required to service the system.

### Call Center Support

Call center support includes the IVR interface, when the IVR detects a request for a live person, the call is transferred to a call center. All the operators are bilingual. When the patient makes a phone call, the system will recognize the nationality of the caller based on the caller ID. When the patient registers his information in the system profile, it requires the patient to choose the language of preference. When the call center receives the phone call, it will automatically transfer the phone call to the operator who speaks the patient's language of preference. This does not include medical emergencies in which a foreign-born, non-bilingual person needs to call 911 because of language barriers and cannot communicate with the 911 operator. The Medifax system operator can record, or store, the message and make an emergency phone call for the patient or user.

The patient can contact the calling center by their own cell phone or the companies issued miniphone with a panic button. If the user calls from a smart phone, they can use installed application software, or an APP, where they can press a virtual button to connect with a network operator.

The dog tag style user ID includes the reminder “I Need Help!” printed in a large font, when the automated network operator hears the key words, it will automatically transfer the call to the live operator who is bilingual and speaks the same language as the user.

If the caller is issued a company miniphone, he just has to press a panic button to connect with a bilingual operator.

There is the prescription drug reminder system. If the patient needs to take a prescription drug routinely, the caregiver can call the Medifax system operator to record their voice in the automated calling system. The automated system will call and remind the patient to take their medication; the reminded can include the type of medication and what the medication looks like. If there is no answer, the machine will call again.

Mobile Device Apps for iOS®, Android®, Windows® Phone, Etc.

These applications will be critical to providing the user interface for viewing patient information, and for uploading addition information if not done at a PC.

### ETL for Non-Digital Medical & Health Records

If initial patient information is not already in a digital format e.g. EHR or HL7 exchange format then ETL (Extract, Transform, Load) are the processes that are required to scan paper patient medical records, convert them to a digital format, and possibly interpret them using OCR. Documents are stored in the DMS, and other information in the EHR.

The computer-based patient information sever/network 100 is a new kind of computer network that allows the medical professionals and the patients themselves to access their medical information through the cellphones and computers. In an emergency situation, time is life. The faster patient information is available to medical providers, the more likely the patient will be saved, especially if the patient is unconscious or cannot speak English.

Each patient is issued a life-saving tag 200, as shown in FIG. 2A. The tag is small and can be hung from the patient's neck or wrist. On the front side 201 of the lifesaving tag 200, there is a toll-free number, a website address, and account number 202. A healthcare professional without any directions would understand the meaning of the tag.

In FIG. 2B, the rear side 211 of the tag 200 includes patient information 212 including, the first line which indicates if the patient is suffering from any serious illness. If there is an exclamation point, the condition is serious. The second line indicates if the patient has any transmittable diseases. The third line indicates if the patient is allergic to anything. The fourth line has his blood type, and the issue date of that tag. This idea is simple. Everyone can easily understand this product without much training Both sides of the tag are marked with the colorful logo 203/213 and with luciferin to make it easier to see in the dark.

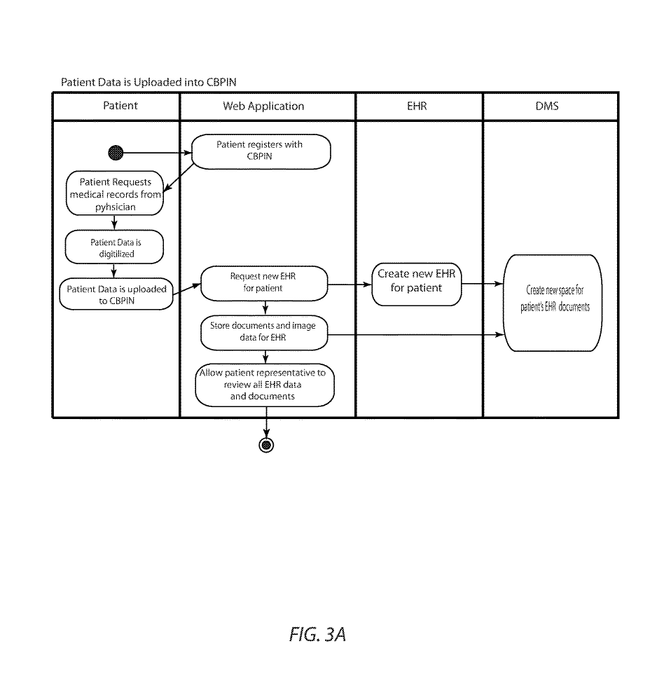

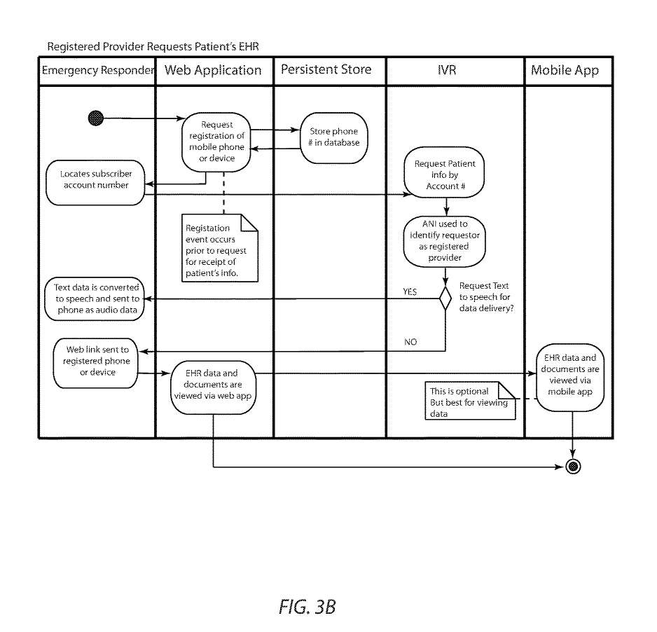

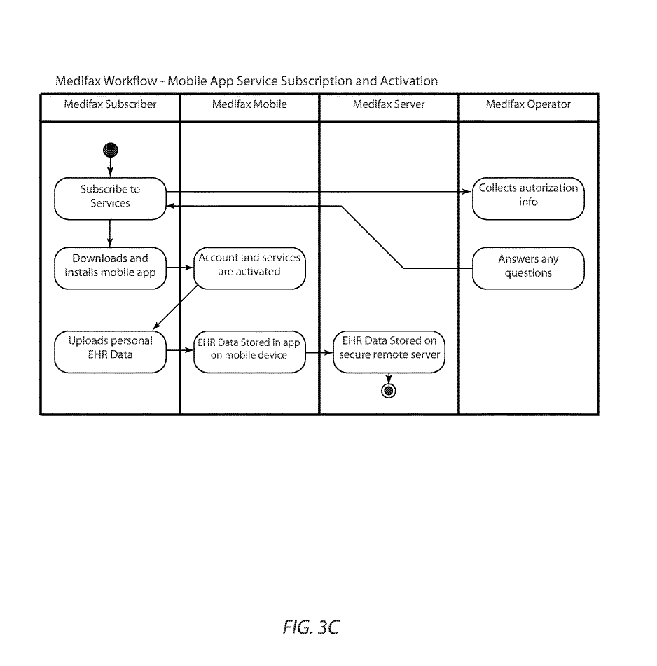

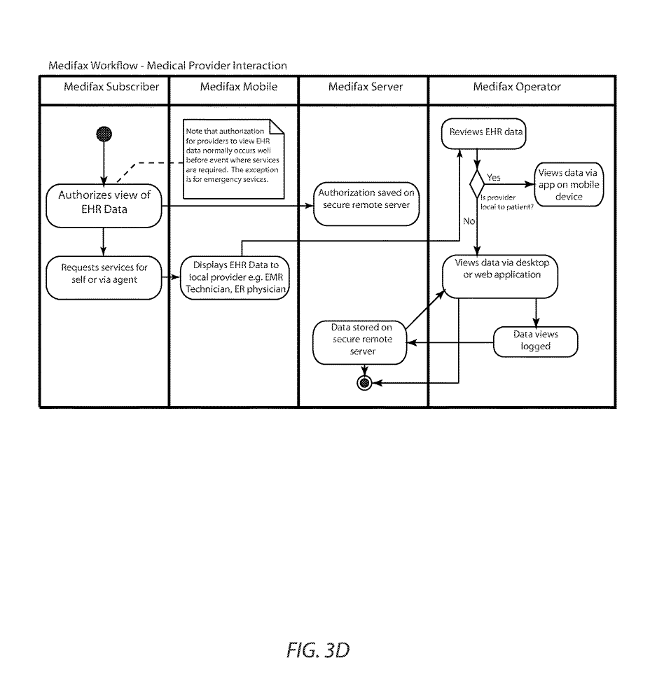

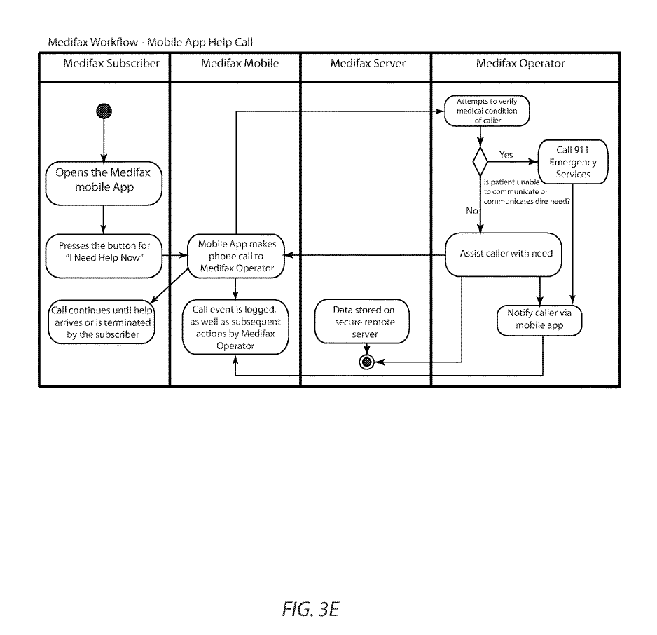

FIGS. 3A through 3E depict the interactions of the components of the centralized medical information system according to an embodiment of the present disclosure. In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure. It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

FIG. 3A represents the initial process of registering a patient and creating a comprehensive database record in the medical information system 100. Following an initial registration, the patient will be required to contact their doctor, or doctors, to request access so their personal medical records can be uploaded into the database 110. In cases where hard copy or paper records are provided, it is contemplated that the records will be digitized prior to being uploaded into the database 110 forming a new Electronic Heath Record (EHR). The EHR requires steps of requesting the EHR, forming a new EHR, and creating or using data server space. All EHR records and data will be subject to secondary review by a patient representative.

FIG. 3B represents the process steps allowing a registered service provider such as a physician or emergency responder access to a patient's EHR. Initial registration of the phone number of the emergency responder is required before they will be granted access to the patients EHR information. Once the emergency responder is registered, the request for information will be tied to the patients account number, the requestor information will again be verified and they will be queried to determine if they would like the information returned as speech or as an image. If speech is requested the EHR text data will be converted to speech and sent to the phone as audio data. If an image is requested it will be provided to the device using either mobile application software or web application software as required by the device.

A mobile application of the medical information system service subscription and activation is described in FIG. 3C. When a patient becomes a subscriber to the information system 100, a system operator will be available by telephone or internet communication e.g. chat, to collect any necessary authorization information and answer the patient's questions. Following the initial consultation with the operator the remainder of the process is accomplished electronically unless the patient requires additional assistance. The patient will first download and install a mobile application 108, where upon completion, the patient's account will be activated. The patient may then download any available personal EHR data which will be stored on the patient, or user's, mobile device and also forwarded to patient medical information server 102 where it is saved to the server database 110.

FIG. 3D describes the interaction between a medical service provider and the medical information system 100. Initially the patient or subscriber is required to authorize viewing of their EHR data and the authorization is save to the secure remote server 102. The request may be initiated by the patient or subscriber or via an authorized agent of the patient. Once authorized the EHR data is sent to the designated provider, such as an emergency responder or an emergency room physician, the data can then be reviewed via mobile device application software 108 or a computer workstation as available. Each authorization transaction and record viewing event is logged into the remote server database.

A mobile application “I need Help” scenario within the present medical information system is detailed in FIG. 3E. In the event a patient or subscriber determines a need to use the “Help” system 100 they will first open the system mobile application 108 on their personal device where they can press a readily apparent button which indicates “I Need Help Now”, this message will be relayed by the mobile application 108 to a system operator. The call event will be logged into the database 110 and include any actions by the operator. The system operator will speak with the caller to assess the patient or subscribers medical condition; if the caller is unable to communicate the operator will immediately contact emergency services via a 911call, the caller will then be notified of the contact with 911 via the mobile application 108 and by direct communication with the operator. If the caller can communicate, the system operator will render the necessary assistance. All event information will be stored on the secure remote server 102.

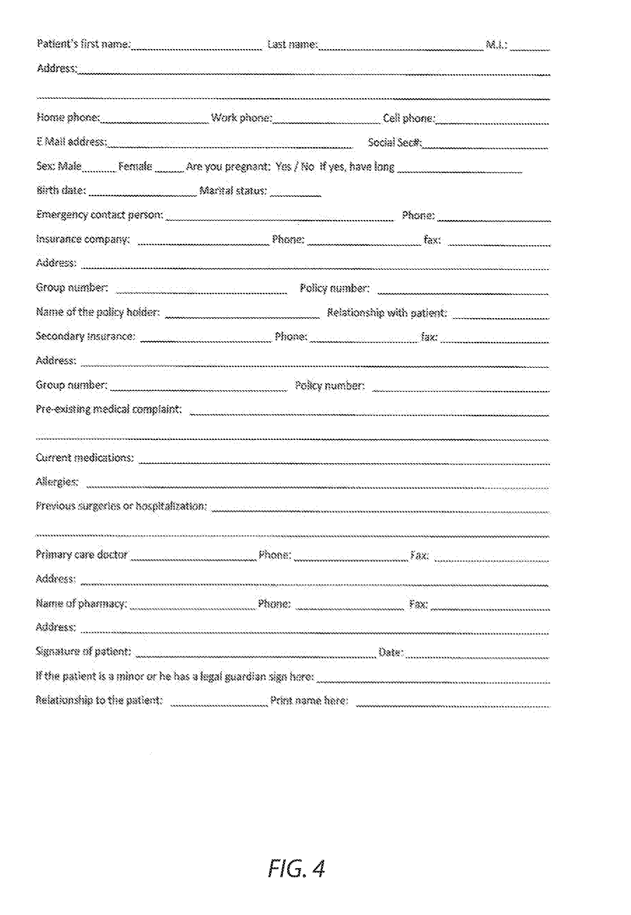

An initial patient or subscriber intake form is shown in FIG. 4. The intake form includes all patient's personal information, emergency contact, insurance information, primary care doctor information, pharmacy and record any previous medical conditions or allergies. The intake form shown is by example only and the disclosure should not be limited to the information displayed.

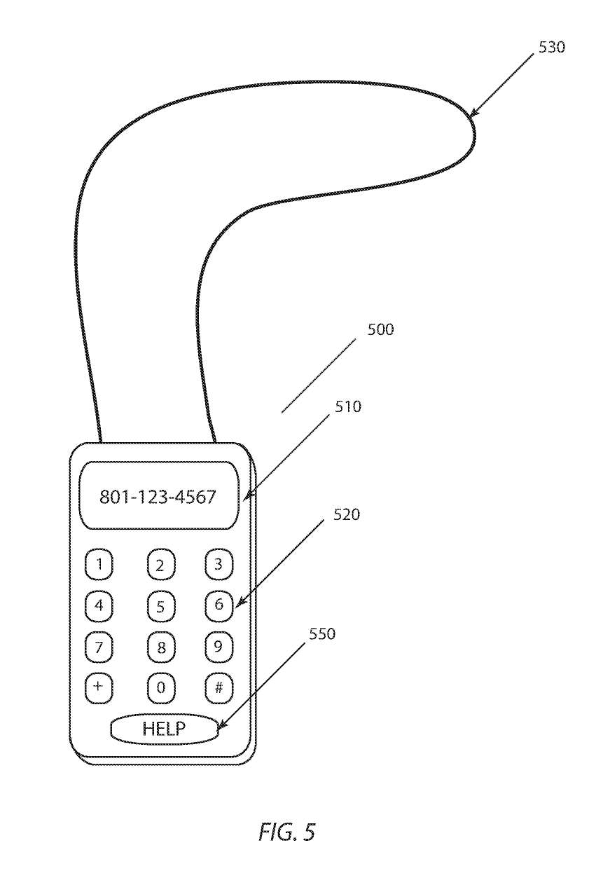

FIG. 5 is one embodiment of the miniphone 500 of the present invention. It is contemplated that the miniphone 500 includes a typical phone key pad 520 having a plurality of keys used to input a phone number, or possibly, text into the miniphone device and a display 510 showing both phone numbers from incoming calls and key press events on the miniphone. In one embodiment the display will also be capable of displaying text information both from user input or messages sent to the device by a system operator. Miniphone 500 may also have a retention device such as a neck loop or strap 530, as shown, or may be secured using a wrist strap or clip configured to be attached to a user's belt, waistband or pocket. In yet another embodiment, it is contemplated that the neck loop 530 is also an antenna configured to improve the reception and transmission performance of the device. The miniphone may also include a discrete panic or HELP button 550 that when depressed will immediately connect the subscriber with a system operator, who may communicate with subscriber to render help or initiate a 911 call as necessary.

1. A centralized medical information system comprising;
a user,
a medical provider,
an information server,
the information server including a voice recognition program,
a medical database stored on the information server,
a plurality of records,
the plurality of records stored in the medical database,
the plurality of records including at least an electronic health record for the user,
the user electronic health record information including at least,
a user identification number,
a user pin number,
a secure user login,
a preferred language,
a user voice print,
a provider authorization,
the electronic health record is retrievable, and,
the electronic health record may be updated.

2. The medical information system of claim 1 wherein the secure login is the user voice print in conjunction with the user pin number.

3. The medical information system of claim 1 wherein the medical provider can access the electronic heath record using the provider authorization.

4. The medical information system of claim 1 including a physical account identifier comprising;
a medical information system identifier,
a toll free phone number,
a web page address,
the user identification number,
an “I Need Help” visual prompt,
a serious illness notice,
a transmitted disease notice,
an allergy notice, and,
a user blood type.

5. The medical information system of claim 4 wherein the physical account identifier is one of a dog tag, a necklace, a bracelet and a card.

6. The medical information system of claim 1 including a mobile device application software,
the software configured,
to communicate with the information server,
to display the electronic heath record of the user, and,
to convey the electronic heath record of the user as speech.

7. The medical information system of claim 1 wherein voice recognition software provides interactive voice response.

8. The medical information system of claim 1 including call center support.

9. The medical information system of claim 8 wherein the call center includes a plurality of operators, and,
the plurality of operators are bilingual.

10. The medical information system of claim 9 wherein when a user contacts the call center, the call is routed to one plurality of operators based on the user's preferred language.

11. The medical information system of claim 1 wherein the electronic health record of the user includes text records and diagnostic images.

12. The medical information system of claim 1 including a miniphone provided to the user.

13. The medical information system of claim 12 wherein the miniphone includes a help button.

14. A method of using a medical information server comprising;
providing an information server,
the information server including a voice recognition program,
providing a medical database stored on the information server,
providing a plurality of records,
the plurality of records stored in the medical database,
the plurality of records including at least one electronic health record for a user,
the electronic health record including at least,
a secure user login,
the secure user login including,
a user identification number,
a user pin number,
a secure user login,
a preferred language for the user,
a user voice print,
a provider authorization,
propagating the electronic health record including,
retrieving electronic user medical records from physicians and insurance providers,
retrieving paper records for the user from physicians and insurance providers,
scanning paper records into electronic form,
providing a mobile device having system application software,
accessing the electronic health record using the mobile device and using the secure login,
a health service provider using the electronic health record to ascertain vital user health information, diagnose, and treat the user,
the user using the electronic heath record to view historical information,
updating the electronic health record following health service provider treatment,
providing a call center,
the call center having operators, and,
the call center operators are bilingual.

15. The method of using the medical information system of claim 14 wherein the secure login by the user comprises the user providing a voice sample and the user pin number.

16. The method of using the medical information system of claim 14 wherein when a user contacts the call center they are connected to an operator who speaks the preferred language.

17. The method of using the medical information system of claim 14 including providing a physical account identifier comprising;
a medical information system identifier,
a toll free phone number,
a web page address,
the user identification number,
an “I Need Help” visual prompt,
a serious illness notice,
a transmitted disease notice,
an allergy notice, and,
a user blood type.

18. The method of using the medical information system of claim 17 wherein when the user contacts the call center and says, “I Need Help”, the information server will immediately connect the user to an operator speaking the preferred language.

19. The method of using the medical information system of claim 14 including providing a miniphone comprising;
the miniphone having a help button wherein when the user presses the help button, the information server will immediately connect the user to an operator speaking the preferred language.

20. The method of using the medical information system of claim 19 wherein the miniphone is enabled to provide a recorded voice of the medical provider as a prescription reminder.
